(19) United States
(12) Patent Application Publication
(10) Pub. No.: US 2009/0147847 A1
(43) Pub. Date: Jun. 11, 2009

(54) IMAGE CODING METHOD AND APPARATUS, AND IMAGE DECODING METHOD

(76) Inventors: Yasuo Ishii, Gifu (JP); Hirotoshi Mori, Gunma (JP); Shigeyuki Okada, Gifu (JP)

Correspondence Address: MCDERMOTT WILL & EMERY LLP, 600 13TH STREET, N.W., WASHINGTON, DC, 20005-3096, US

(21) Appl. No.: 11/887,335

(22) PCT Filed: Feb. 9, 2006
(86) PCT No.: PCT/JP2006/302279

§ 371 Date: Sep. 28, 2007

(30) Foreign Application Priority Data
Mar. 31, 2005 (JP) 2005-100891

(51) Int. Cl. H04N 7/32; H04N 7/26

(52) U.S. Cl. 375/240.13; 375/240.01; 375/E07.243; 375/E07.124

(57) ABSTRACT

An encoding apparatus 100 performs intra-frame encoding or inter-frame encoding using a predetermined scheme, or performs an orthogonal transform on an image as one process in the intra-frame encoding or the inter-frame encoding. In order to perform the intra-frame encoding, the inter-frame encoding, or the orthogonal transform, various parameters to be specified by the encoding apparatus are specified as an abbreviated parameter which uses a number of bits less than the number of bits that is assigned by the specification. This enables to reduce the data amount of a parameter in the coded data.

### TECHNICAL FIELD

The present invention relates to an image encoding method and apparatus for encoding moving images, and to an image decoding method for decoding encoded moving images.

### BACKGROUND TECHNOLOGY

Broadband networks are being rapidly developed, and high expectations are being placed on those services which utilize high quality moving images. Mass storage media such as DVDs are also being utilized, so that the number of users who enjoy high quality images is also increasing. There is a compression coding technology available which is essential for transmitting moving images over telecommunication lines and storing those images on storage media. There are several international standards available for the moving image compression coding technology, such as the MPEG 4 Standard and H.264/AVC Standard. There are also next-generation image compression technologies, such as SVC (Scalable Video Codec), which allows one stream to include a high image quality stream and a low image quality stream at the same time.

Disclosed in Patent Document 1 is a technology for automatically adaptively setting the size and shape of a block, which outputs a motion vector, according to the spatial frequency of an input image.

[Patent Document 1] Japanese Patent Application Laid-Open No. Hei 5-7327

### DISCLOSURE OF THE INVENTION

In order to deliver high-resolution moving images in streams or to store those images on storage media, the compression rate of moving-image streams needs to be enhanced so that communication bands will not be excessively occupied or an excessively high storage capacity will not be required. The H.264/AVC Standard has a higher degree of design flexibility than the MPEG-4 Standard or the like in terms of inter-frame predictions and intra-frame predictions. Use of the H.264/AVC Standard, however, leads to an increase in the amount of coding of various parameters that is required to be specified by encoding apparatuses. An increase in the amount of coding would present one impediment to the enhancement of the compression rate of moving-image streams.

The present invention was developed in view of these problems, and a general purpose thereof is to provide an encoding technique which enables a reduction in the amount of coding that is required when moving images are compressed and encoded.

One embodiment of the present invention provides an image encoding method in which a parameter to be referenced in each step of a predetermined encoding process is specified as an abbreviated parameter using a number of bits that is less than the number of bits that is assigned to the parameter according to a specification of the encoding process.

According to this embodiment, the use of the abbreviated parameter reduces the data amount of the parameter, thereby making it possible to reduce the amount of coded data.

Another embodiment of the present invention also relates to an image encoding method. This method is intended to control an encoding process in an encoding apparatus which performs intra-frame encoding or inter-frame encoding using a predetermined scheme, or performs an orthogonal transform on an image as one process of the intra-frame encoding or the inter-frame encoding. In this method, various parameters, which need to be specified by the encoding apparatus to perform the intra-frame encoding, the inter-frame encoding, or the orthogonal transform, are specified as an abbreviated parameter with a number of bits less than the number of bits that is assigned according to a specification.

According to this embodiment, the parameter required for performing the intra-frame encoding, the inter-frame encoding, or the orthogonal transform is specified as an abbreviated parameter, thereby making it possible to reduce the amount of coded data required.

The number of bits of the abbreviated parameter may be set in a stepwise manner according to the resolution of the moving images being encoded. For example, such an abbreviated parameter with an upper limit on the number of bits may be set for a low-resolution image, whereas a parameter having the number of bits according to the specification may be set for a high-resolution image. According to this embodiment, an optimal encoding process can be used for a high-resolution image. Thus, the abbreviated parameter is employed to restrict the function of the encoding process, while an adverse effect on the image quality may be avoided.

Yet another embodiment of the present invention relates to an image encoding apparatus. This apparatus is an image encoding apparatus which performs intra-frame encoding or inter-frame encoding using a predetermined scheme, or performs an orthogonal transform on an image as one process of the intra-frame encoding or the inter-frame encoding. The encoding apparatus includes a control unit which specifies each of the various parameters as an abbreviated parameter with a number of bits less than the number of bits that is assigned according to the specification. In this embodiment, the various parameters are specified by the encoding apparatus in order to perform the intra-frame encoding, the inter-frame encoding, or the orthogonal transform.

According to this embodiment, the number of bits of an abbreviated parameter specified by the control unit is restricted or the number of bits is specified according to the specification. This makes it possible to provide a balance between an increase in image quality and a reduction in the amount of coded data required.

The control unit may further include a parameter restriction unit whish sets the number of bits of the abbreviated parameter in a stepwise manner according to the resolution of the moving images being encoded. Additionally, the control unit may further include a parameter information embedding unit which embeds, in a user definition area of an encoded stream, information regarding which of a parameter of the normal number of bits or an abbreviated parameter has been used for the encoding process.

Still another embodiment of the present invention provides an image decoding method in which, assuming that the image data encoded by the aforementioned method is described with the abbreviated parameter, the abbreviated parameter is interpreted for performing a decoding process.

According to this embodiment, a decoding apparatus which decodes only the image data encoded using an abbreviated parameter can perform the decoding operation at a reduced cost.

Yet another embodiment of the present invention provides an image decoding apparatus in which, assuming that the image data encoded by the aforementioned image encoding apparatus is described with the abbreviated parameter, the abbreviated parameter is interpreted for performing a decoding process.

It should be appreciated that any combinations of the foregoing components, and any conversions of expressions of the present invention from/into methods, apparatuses, systems, recording media, computer programs, and the like are also intended to constitute applicable aspects of the present invention.

### EFFECTS OF THE INVENTION

According to the present invention, the number of bits of a parameter to be referenced in each step of an encoding process is restricted, thereby allowing for a reduction in the amount of coded data required.

### BRIEF DESCRIPTION OF THE DRAWINGS

FIG. 1 is a block diagram showing an encoding apparatus according to an embodiment;

FIG. 2 is an explanatory view showing a parameter used to specify the size of areas for motion correction predictions;

FIG. 3 is an explanatory view showing exemplary predictive modes for an intra-frame prediction;

FIG. 4 is an explanatory view showing a parameter for specifying the predictive modes of FIG. 3;

FIG. 5 is an explanatory view showing parameters for specifying the number of motion vectors and the amount of data;

FIG. 6 is an explanatory view showing a parameter for specifying the number of reference frames in a motion correction prediction;

FIG. 7 is an explanatory view showing a parameter for specifying the size of a unit area on which an orthogonal transform is performed; and

FIG. 8 is a block diagram showing a decoding apparatus according to an embodiment.

### DESCRIPTION OF REFERENCE NUMERALS

10 area division unit, 12 differentiator, 14 adder, 16 parameter restriction unit, 20 DCT unit, 30 quantization unit, 40 inverse quantization unit, 50 inverse DCT unit, 60 motion correction prediction unit, 80 frame buffer, 90 variable-length encoding unit, 100 encoding apparatus

### THE BEST MODE FOR CARRYING OUT THE INVENTION

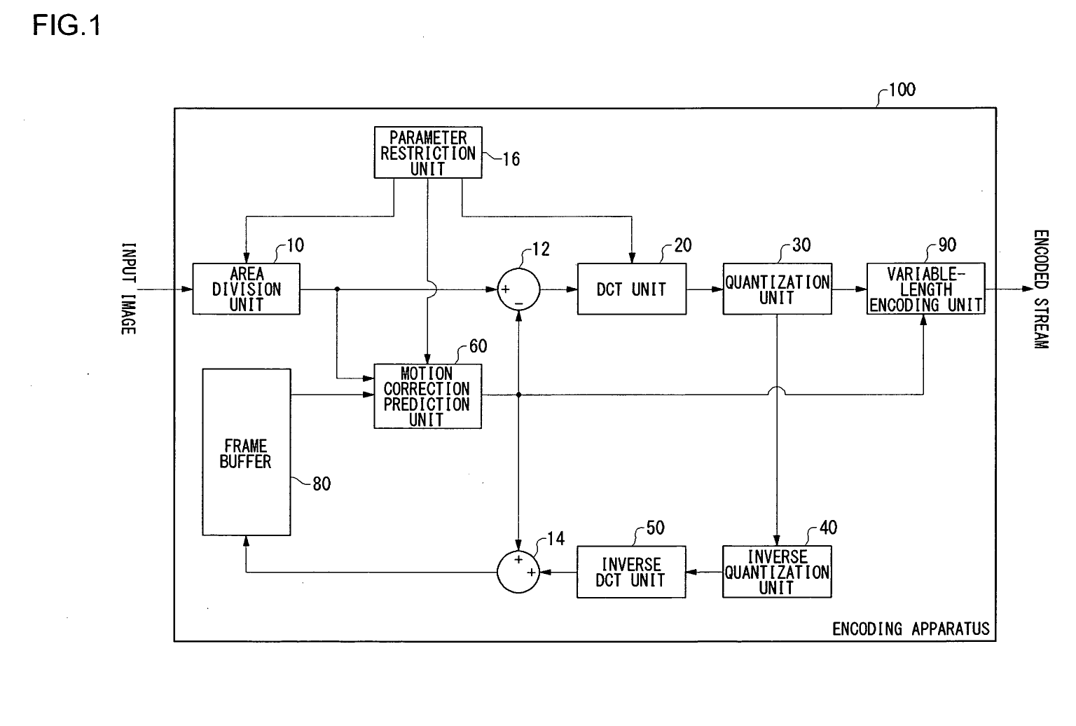

FIG. 1 is a block diagram of an encoding apparatus 100 according to an embodiment. The structure as illustrated may be implemented by hardware including a CPU, a memory and an LSI of an arbitrary computer and by software including a program provided with image coding functions loaded into the memory. FIG. 1 depicts functional blocks implemented by the cooperation of the hardware and software. Therefore, it will be obvious to those skilled in the art that the functional blocks may be implemented by a variety of manners including hardware only, software only or a combination of both.

The encoding apparatus 100 of the present embodiment encodes moving images in conformity with the H.264/AVC Standard, which is a moving image compression coding standard.

In the MPEG series Standards, an image frame for intra-frame encoding is referred to as an I (Intra) frame, an image frame for forward inter-frame predictive encoding with a past frame employed as a reference image is referred to as a P (Predictive) frame, and an image frame for bi-directional inter-frame predictive encoding with past and future frames employed as reference images is referred to as a B frame.

In contrast, in the H.264/AVC Standard, two past frames or two future frames may be utilized as reference images irrespective of whether the frame is past or future one. Additionally, no limitations are imposed on the number of frames which can be utilized as reference images. For example, three or more frames can be used as reference images. Accordingly, it is important to note that in the MPEG-1/2/4 Standard, the B frame refers to a bi-directional prediction frame, but in the H.264/AVC Standard, the B frame refers to a bi-predictive frame because whether the reference image is a past or future one is not considered.

It should be noted that as used herein, the terms “frame” and “picture” have the same meaning, and thus the I frame, the P frame, and the B frame are also referred to as an I picture, a P picture, and a B picture, respectively.

The encoding apparatus 100 receives moving images in frames as input, and encodes the moving images to output the encoded streams.

An area division unit 10 divides an input image frame into a plurality of areas. The area may be a rectangular area, a square area, or an object by object area.

The area corresponds to a macro block in the MPEG-4 Standard. When employing a rectangular area or a square area, areas are formed sequentially from the upper left to the lower right of an image frame. The area division unit 10 supplies produced areas to a differentiator 12 and a motion correction prediction unit 60.

If the image frame supplied from the area division unit 10 is I frame, the differentiator 12 outputs it to a DCT unit 20 as it is. However, if the image frame supplied from the area division unit 10 is the P frame or the B frame, the differentiator 12 computes the difference between the supplied frame and the predictive image supplied from the motion correction prediction unit 60 and then gives the result to the DCT unit 20.

The motion correction prediction unit 60 utilizes a past or future image frame stored in a frame buffer 80 as a reference image to make a motion correction to each area of the P frame or the B frame input from the area division unit 10, thereby producing a motion vector and a predictive image. The motion correction prediction unit 60 supplies the produced motion vector to a variable-length encoding unit 90, while the unit 60 supplies the produced predictive image to the differentiator 12 and an adder 14.

The differentiator 12 calculates the difference between the current image delivered from the area division unit 10 and the predictive image delivered from the motion correction prediction unit 60, and then outputs the resulting difference to the DCT unit 20. The DCT unit 20 performs a discrete cosine transform (DCT) on the differential image given by the differentiator 12, and provides a DCT coefficient to a quantization unit 30.

The quantization unit 30 quantizes the DCT coefficient, and provides the resulting DCT coefficient to the variable-length encoding unit 90. The variable-length encoding unit 90 performs variable-length encoding on the quantized DCT coefficient of the differential image along with the motion vector provided by the motion correction prediction unit 60, thereby producing an encoded stream. When producing encoded streams, the variable-length encoding unit 90 rearranges the encoded frames in order of time.

The quantization unit 30 supplies the quantized DCT coefficient of the image frame to an inverse quantization unit 40. The inverse quantization unit 40 inversely quantizes the quantized data provided and then supplies the resulting data to an inverse DCT unit 50. The inverse DCT unit 50 performs an inverse discrete cosine transform on the inversely quantized data provided to it. This allows for decoding the encoded image frame. The decoded image frame is then supplied to the adder 14.

If the image frame supplied from the inverse DCT unit 50 is the I frame, then the adder 14 stores it in the frame buffer 80 without any process. If the image frame supplied from the inverse DCT unit 50 is the P frame or the B frame, the frame is a differential image. The adder 14 then adds the differential image supplied from the inverse DCT unit 50 and the predictive image supplied from the motion correction prediction unit 60 together, thereby reconstructing the original image frame, which is then stored in the frame buffer 80.

In the case of an encoding process for the P frame or the B frame, the motion correction prediction unit 60 operates as described above. However, in the case of an encoding process for the I frame, the motion correction prediction unit 60 will not be activated, and an intra-frame prediction is performed (not shown here).

Based on the resolution of the input image, a parameter restriction unit 16 issues an instruction as to whether to specify a parameter of the number of bits defined in the specification or in the standard or to specify an abbreviated parameter of a number of bits less than the number of bits defined in the specification. In this instance, the parameter is to be specified in the encoding process in the area division unit 10, the motion correction prediction unit 60, and the DCT unit 20. Examples of this parameter will be shown as Embodiments 1 to 5. The information on the resolution of the input image may be provided from an external device to the parameter restriction unit 16, or alternatively, the user may supply the resolution information to the parameter restriction unit 16.

The H.264/AVC Standard is a moving image encoding scheme which employs the same basic algorithm as that of the conventional moving image encoding scheme and, at the same time, realizes a high encoding efficiency with improved encoding tools. The H.264/AVC Standard is designed to adapt to a wide variety of applications from a low-resolution and low bit rate application as used for videophones to a high-resolution and high bit rate application as used for HDTV. Therefore, it is predicted that H.264/AVC Standard will be used in the variety of applications. For this reason, the H.264/AVC Standard has a variety of predictive modes and block sizes as its standards for an intra-frame prediction and an inter-frame prediction, and is thus designed with a higher degree of flexibility when compared with a moving image encoding scheme such as the MPEG-4 Standard. Thus, there is an advantage that adequate encoding can be selected to each image according to the feature of the image.

H.264/AVC Standard, however, requires parameters for specifying which predictive mode and block size are used for encoding in addition to pixel data due to its high flexibility, thereby increasing the data amount of coding required.

Therefore, according to the present embodiment, for high-resolution input images, the quality of image is improved by use of a parameter with the maximum encoding capability as allowed by the H.264/AVC Standard in each step of the encoding process. For low-resolution input images, an abbreviated parameter is used which has a reduced number of parameter bits by restricting the degree of flexibility of the encoding process. In the latter case, image quality may possibly be decreased when compared with a case where a normal parameter is used. However, for low-resolution images, the quality of image would not be noticeably decreased.

A description will now be made to a process of restricting the data amount of parameter in accordance with an example of encoding a moving image in conformity with the H.264/AVC Standard.

### EMBODIMENT 1

The motion correction prediction unit 60 searches the reference image for the prediction area which has the lowest error relative to each of the areas divided by the area division unit 10 in order to determine a motion vector indicative of the deviation of a prediction area from a target area. The motion correction prediction unit 60 uses the motion vector to perform a motion correction to the target area and thereby produce a predictive image, and then delivers the differential image between the image to be encoded and the predictive image to the DCT unit 20.

In the present embodiment, the area sizes prepared for the aforementioned motion correction include seven sizes: a 16×16 pixel unit, a 16×8 pixel unit, an 8×16 pixel unit, an 8×8 pixel unit, an 8×4 pixel unit, a 4×8 pixel unit, and a 4×4 pixel unit. The parameter is used to specify the various sizes. Accordingly, the standard number of 3 bits is assigned to the parameter for specifying the size. A motion correction made to smaller size areas would reduce the predictive error per unit area, thereby providing a high-resolution image.

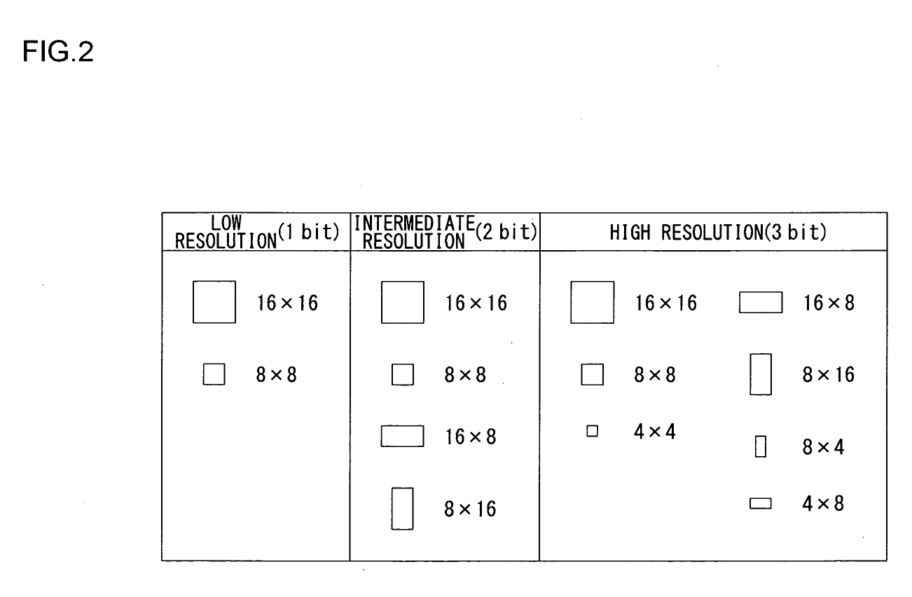

When the encoding apparatus 100 processes a low-resolution image or an intermediate-resolution image, the parameter restriction unit 16 specifies an abbreviated parameter. For example, the abbreviated parameter has a one-bit length for the low resolution image, and a two-bit length for the intermediate resolution image. FIG. 2 shows an example of the restricted area sizes for each resolution. As illustrated, for a low resolution image, an abbreviated parameter can be used to specify either one of 2 area sizes, i.e., a 16×16 pixel unit or an 8×8 pixel unit. For an intermediate resolution image, an abbreviated parameter can be used to specify any one of 4 area sizes, i.e., a 16×16 pixel unit, an 8×8 pixel unit, a 16×8 pixel unit, or an 8×16 pixel unit. For a high resolution image, any one of the aforementioned seven sizes can be selected. As such, the area sizes which can be specified are restricted, thereby allowing for reducing the data amount of parameter.

### EMBODIMENT 2

To reduce the spatial redundancy in a frame, a pixel level prediction is executed from an adjacent block, thereby making an intra-frame prediction. It should be understood that the present embodiment defines nine predictive modes for a 4×4 pixel blocks that are used to select which pixel of the adjacent blocks when making this pixel level prediction. Note that the motion correction prediction unit 60 predicts a pixel value in an intra-frame prediction.

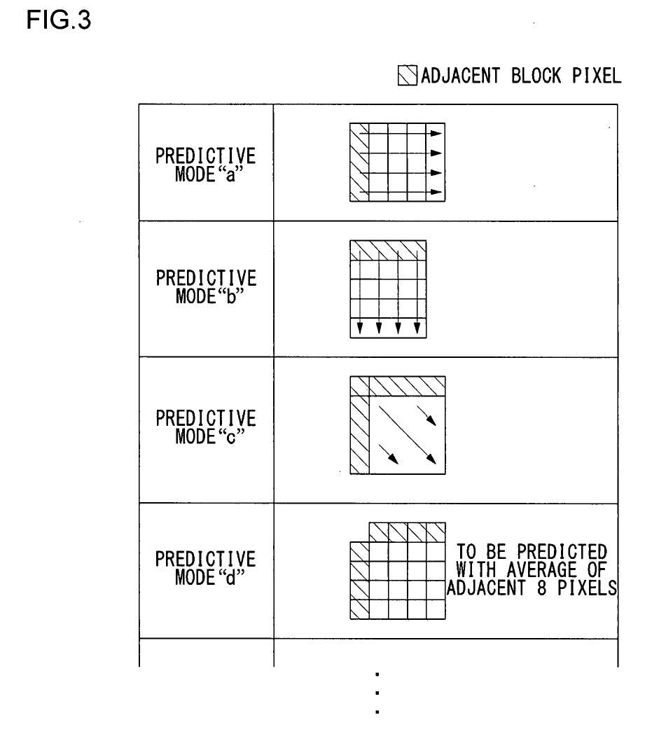

FIG. 3 shows an example of predictive modes. A predictive mode “a” uses pixel data adjacent to the left of the 4×4 pixel blocks to be predicted, to make a prediction in the horizontal direction in order to produce a predictive image. A predictive mode “b” uses pixel data adjacent to the upside of the 4×4 pixel blocks to be predicted, to make a prediction in the vertical direction in order to produce a predictive image. A predictive mode “c” uses pixel data adjacent to the upside, to the left and to the upper-left of the 4×4 pixel blocks to be predicted, to make a prediction in the diagonal direction in order to produce a predictive image. A predictive mode “d” uses the average value of pixel data adjacent to the upside and to the left of the 4×4 pixel blocks to be predicted in order to produce a predictive image. It should be understood that there are nine predictive modes, i.e., predictive modes “a” to “i” in total including those mentioned above. Accordingly, assuming that all the predictive modes are available, the parameter for specifying the predictive modes is assigned 4 bits.

These predictive modes are already known, and thus will not be described in more detail herein. Having a larger number of predictive modes available would be more likely to aid the finding of an image closer to the area to be encoded. Therefore, it can be expected that the encoding will be performed with improved efficiency.

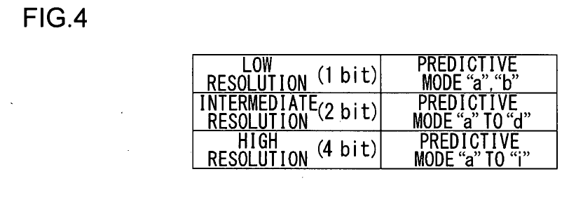

The parameter restriction unit 16 specifies an abbreviated parameter when the encoding apparatus 100 processes a low-resolution image or an intermediate-resolution image. The abbreviated parameter has a one-bit length for the low resolution image, and a two-bit length for the intermediate resolution image. FIG. 4 shows an example of predictive modes which are assigned to each resolution. As illustrated, for a low resolution image, an abbreviated parameter can be used to specify either one of the predictive modes “a” and “b.” For an intermediate resolution image, an abbreviated parameter can be used to specify any one of the 4 predictive modes “a” to “d.” For a high resolution image, any one of the aforementioned nine predictive modes can be specified. As such, the predictive modes which can be specified are restricted, thereby allowing for a reduction in the data amount of parameter required.

### EMBODIMENT 3

The motion correction prediction unit 60 can make either a bi-directional prediction or a one-way prediction. For the one-way prediction, the motion correction prediction unit 60 produces a forward motion vector indicative of the motion relative to the forward reference P frame. For the bi-directional prediction, the motion correction prediction unit 60 produces two motion vectors, i.e., the reverse motion vector indicative of the motion relative to the backward reference P frame as well as the forward motion vector.

Consider the amount of coding required for the motion vectors. For the bi-directional prediction, independent motion vectors are detected in the forward and reverse directions, thereby reducing the differential error relative to the reference image. However, encoding the information on the two independent motion vectors will result in an increase in the amount of coding of the motion vector information required. Additionally, encoding a more rapidly moving scene would cause the motion vector to have a larger absolute value. So, resulting in the amount of coding required tends to be increased. In this context, it is possible to reduce the amount of coding by restricting the amount of coding required for a motion vector and using one motion vector.

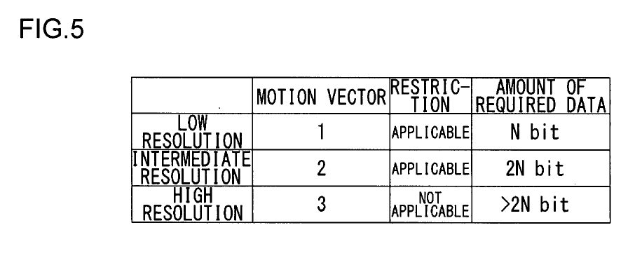

More specifically, as shown in FIG. 5, the encoding apparatus 100 may process a low-resolution image. In this case, the parameter restriction unit 16 is set such that only the forward motion vector is produced in the motion correction prediction unit 60 and the upper limit of the amount of encoding of the vector is restricted to N bits (where N is a natural number). The encoding apparatus 100 may also process an intermediate-resolution image. In this case, the motion correction prediction unit 60 produces two vectors, i.e., the forward motion vector and the reverse motion vector. The parameter restriction unit 16 is set such that the upper limit of the amount of coding of each motion vector is restricted to N bits. When the encoding apparatus 100 process a high-resolution image, a setting is given that provides no upper limit to the amount of encoding.

### EMBODIMENT 4

As described above, the motion correction prediction unit 60 can specify more than one reference frames in forward direction and reverse direction, respectively. Accordingly, a parameter is required for identifying reference frames. In general, a plurality of reference frames may be presented and reference may be made to a bi-directional frame. This would be more likely to aid in finding an image closer to the area to be encoded. Thus, it can be expected that the coding efficiency is improved.

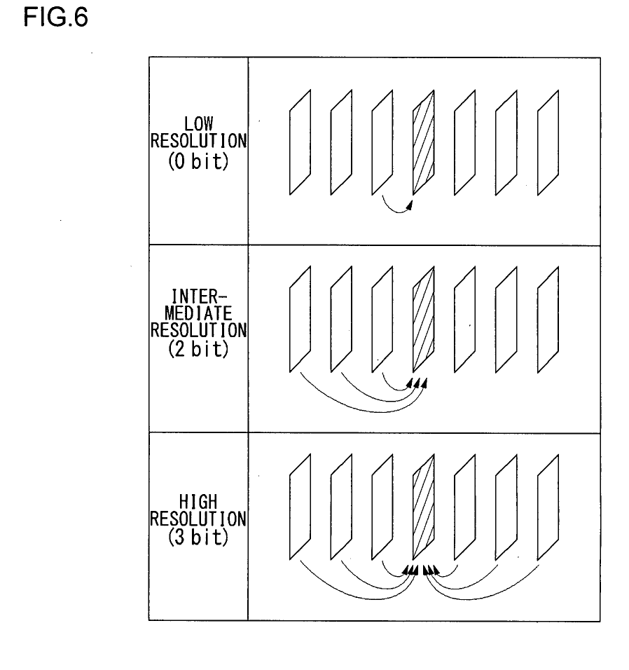

As shown in FIG. 6, when the encoding apparatus 100 processes a low-resolution image, the parameter restriction unit 16 is set to reference one backward frame as in the MPEG-4 Standard. This would eliminate the need for identifying a reference frame, making the data amount of parameter to be 0 bit. When the encoding apparatus 100 processes an intermediate-resolution image, the parameter restriction unit 16 is set such that up to four backward frames may be referenced. In this case, in order to identify a reference frame, the data amount of the parameter is two bits. When the encoding apparatus 100 processes a high-resolution image, the parameter restriction unit 16 is set such that up to four forward frames and up to four backward frames may be referenced. In this case, in order to identify a reference frame, the data amount of the parameter is 3 bits.

As such, restricting the number of reference frames to be used in the motion correction prediction unit 60 allows the data amount of a parameter required for identifying a reference frame to be reduced.

### EMBODIMENT 5

The DCT unit 20 can select three unit area sizes on which DCT is performed, i.e., an 8×8 pixel size, a 4×4 pixel size, and a 16×16 pixel size. Accordingly, assuming that all the sizes are available, the parameter for specifying a unit area size requires 2 bits.

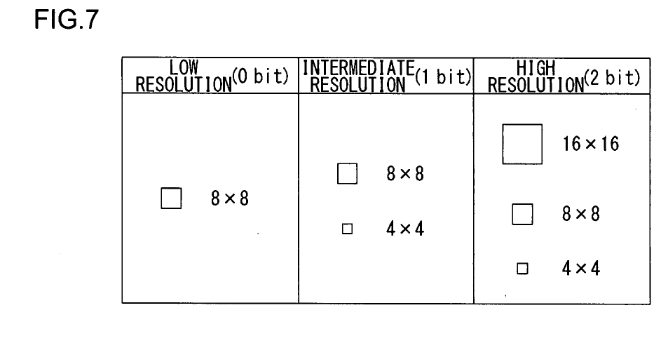

As shown in FIG. 7, when the encoding apparatus 100 processes a low-resolution image, the parameter restriction unit 16 is set such that a fixed 8×8 pixel size is employed and no parameter is used to specify the size. When the encoding apparatus 100 processes an intermediate-resolution image, an abbreviated parameter of one bit is set, allowing two sizes, i.e., an 8×8 pixel size and a 4×4 pixel size, to be specified. As such, simplifying the size specification of a unit area allows the data amount of parameter required to be reduced.

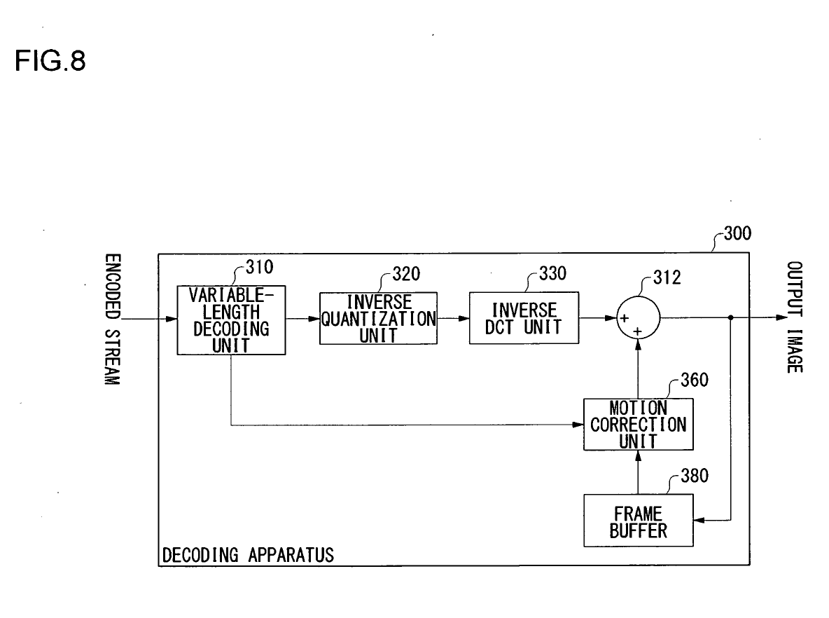

FIG. 8 is a block diagram of a decoding apparatus 300 according to an embodiment. These functional blocks can also be implemented in various forms such as with hardware only, software only, or with a combination thereof. The decoding apparatus 300 is adapted such that the image data encoded by the encoding apparatus 100 using an abbreviated parameter is decoded by interpreting the abbreviated parameter. That is, the decoding apparatus may be differently configured in terms of hardware depending on whether it receives coded data of a low-resolution image or of a high-resolution image.

The decoding apparatus 300 receives an encoded stream as input, and decodes the encoded stream to produce an output image. A variable-length decoding unit 310 performs variable-length decoding on the received encoded stream, supplies the decoded image data to an inverse quantization unit 320, and supplies the motion vector information to a motion correction unit 360.

The inverse quantization unit 320 inversely quantizes the image data decoded by the variable-length decoding unit 310, and supplies the resulting image data to an inverse DCT unit 330. The inverse quantization unit 320 inversely quantizes the image data into a DCT coefficient. The inverse DCT unit 330 performs an inverse discrete cosine transform (IDCT) on the DCT coefficient inversely quantized by the inverse quantization unit 320, thereby recovering the original image data. The image data recovered by the inverse DCT unit 330 is supplied to an adder 312.

If image data supplied from the inverse DCT unit 330 is I frame, the adder 312 outputs the image data of the I frame without any process, and stores it in a frame buffer 380 as a reference image for producing the predictive image of the P frame or the B frame. If the image data supplied from the inverse DCT unit 33Q is the P frame, it is a differential image. Thus, the adder 312 adds the differential image supplied from the inverse DCT unit 330 and the predictive image supplied from the motion correction unit 360 together, thereby recovering the original image data for output.

The motion correction unit 360 uses the motion vector information supplied from the variable-length decoding unit 310 and the reference image stored in the frame buffer 380 to produce the predictive image of the P frame or the B frame, which is in turn supplied to the adder 312.

The motion correction unit 360 and the inverse DCT unit 330 perform the aforementioned process on the assumption that the coded data is described with an abbreviated parameter. It is thus possible to perform the decoding process at a reduced cost.

As described above, according to the present embodiment, as various parameters to be specified to perform an intra-frame prediction, an inter-frame prediction, and an orthogonal transform, an abbreviated parameter is specified which has a reduced number of bits to be assigned to the parameter. This allows for a reduction in the data amount of a parameter in the coded data, thereby providing improved compression rates. Additionally, when only a low-resolution moving image is reproduced on the decoding side, it is possible to perform the decoding operation at reduced costs.

In the foregoing description, the present invention has been described in accordance with various embodiments. It will be understood by those skilled in the art that the embodiments were provided by way of example only, and that various modifications may be made to each component thereof or to the combinations of each process step, and those modifications may also fall within the scope of the present invention.

In a process step other than the encoding process described above, it is also possible to restrict a parameter which is available according to a standard. For example, with two entropy encoding processes available, a restriction can be made so that only either one of the encoding processes is used.

In the aforementioned embodiments, the decoding apparatus 300 is configured such that the image data encoded by the encoding apparatus 100 using an abbreviated parameter is decoded by interpreting the abbreviated parameter. However, the decoding apparatus may also be configured such that the image data encoded by the encoding apparatus 100 using an abbreviated parameter or a normal parameter is decoded according to the result of a determination of whether the abbreviated parameter or the normal parameter has been used by the decoding apparatus. For example, the encoding apparatus 100 may include a parameter information embedding unit (not shown) which stores information in a user definition area available to the user in an encoded stream. The information relates to the normal parameter or the abbreviated parameter which has been used in the area division unit 10, the DCT unit 20, and the motion correction prediction unit 60. The decoding apparatus 300 includes a parameter interpretation unit (not shown) which receives an encoded stream and interprets the information indicative of which one of the normal parameter and the abbreviated parameter has been used in the encoding apparatus 100 or the information on the predictive mode or the shape and size of an area and so on, which are specified by the parameters. The parameter interpretation unit provides the interpreted information to the inverse quantization unit 320, the inverse DCT unit 330, and the motion correction unit 360, so that these functional blocks perform respective decoding processes in accordance with the parameter information provided. This allows a decoding apparatus having common hardware to decode both the coded data of a low-resolution image and the coded data of a high-resolution image.

### INDUSTRIAL APPLICABILITY

According to the present invention, the number of bits of a parameter to be referenced in each step of an encoding process is restricted, thereby reducing the amount of coded data.

1. An image encoding method, wherein a parameter to be referenced in each step of a predetermined encoding process is specified as an abbreviated parameter using a number of bits that is less than the number of bits that is assigned to the parameter according to a specification of the encoding process.

2. An image encoding method for controlling an encoding process in an encoding apparatus which performs intra-frame encoding or inter-frame encoding using a predetermined scheme, or performs an orthogonal transform on an image as one process of the intra-frame encoding or the inter-frame encoding,
wherein various parameters, which need to be specified by the encoding apparatus to perform the intra-frame encoding, the inter-frame encoding, or the orthogonal transform, are specified as an abbreviated parameter with a number of bits less than the number of bits that is assigned according to a specification.

3. The image encoding method according to claim 2, wherein the number of bits of the abbreviated parameter is set in a stepwise manner according to a resolution of moving images being encoded.

4. An image encoding apparatus for performing intra-frame encoding or inter-frame encoding using a predetermined scheme, or performing an orthogonal transform on an image as one process of the intra-frame encoding or the inter-frame encoding, the encoding apparatus comprising a control unit which specifies each of the various parameters as an abbreviated parameter with a number of bits is less than the number of bits that is assigned according to the specification in order to perform the intra-frame encoding, the inter-frame encoding, or the orthogonal transform.

5. The image encoding apparatus according to claim 4, wherein the control unit comprises:
an area division unit which divides an input image to be processed into areas;
a motion correction prediction unit which produces a motion vector and a predictive image for each divided area;
an orthogonal transform unit which performs an orthogonal transform on a differential image between an image of the divided area and a predictive image; and
a compression unit which quantizes and compresses the differential image after the orthogonal transform,
wherein the abbreviated parameter comprises at least any one indication of:
a) a shape or size of an unit area divided by the area division unit,
b) a size of a unit area on which the orthogonal transform unit performs the orthogonal transform,
c) a number of motion vectors and an amount of data in the motion correction prediction unit,
d) a number of referenced frames in the motion correction prediction unit, and
e) a predictive mode specified for intra-frame encoding in the motion correction prediction unit.

6. The image encoding apparatus according to claim 5, wherein the control unit further comprises a parameter restriction unit whish sets the number of bits of the abbreviated parameter in a stepwise manner according to the resolution of the moving images being encoded.

7. The image encoding apparatus according to claim 5, wherein the control unit further comprises a parameter information embedding unit which embeds, in a user definition area of an encoded stream, information regarding which of a parameter of the normal number of bits or an abbreviated parameter has been used for the encoding process.

8. An image decoding method, comprising assuming that the image data encoded by the method according to claim 1 is described with the abbreviated parameter, and interpreting the abbreviated parameter for performing a decoding process.

9. The image encoding apparatus according to claim 6, wherein the control unit further comprises a parameter information embedding unit which embeds, in a user definition area of an encoded stream, information regarding which of a parameter of the normal number of bits or an abbreviated parameter has been used for the encoding process.

10. An image decoding method, comprising assuming that the image data encoded by the method according to claim 2 is described with the abbreviated parameter, and interpreting the abbreviated parameter for performing a decoding process.

11. An image decoding method, comprising assuming that the image data encoded by the method according to any of claim 3 is described with the abbreviated parameter, and interpreting the abbreviated parameter for performing a decoding process.
